(19) United States
(12) Patent Application Publication
(10) Pub. No.: US 2026/0359120 A1
(43) Pub. Date: Nov. 12, 2026

(54) MACHINE LEARNING-BASED SELECTION OF CLOUD SERVICE TIERS FOR WORKLOAD EXECUTION

(71) Applicant: Dell Products L.P., Round Rock, TX (US)

(72) Inventors: Avinash Kumar, Patna (IN); Parminder Singh Sethi, Punjab (IN); Mohit Kumar Agarwal, Cyberjaya (MY)

(21) Appl. No.: 19/200,994

(22) Filed: May 7, 2025

(51) Int. Cl. G06F 9/50

(52) U.S. Cl. CPC G06F 9/5027

(57) ABSTRACT

An apparatus comprises at least one processing device configured to determine a workload to be executed on one or more clouds of one or more cloud service providers for a given user, the workload being associated with a user-defined resource allocation specification. The at least one processing device is also configured to determine cloud service tiers offered by the cloud service providers, each cloud service tier being associated with a cloud service provider-defined performance level and set of features. The at least one processing device is further configured to generate, utilizing at least one machine learning model, a set of mappings between (i) the cloud service provider-defined performance levels and sets of features to (ii) the user-defined resource allocation specification. The at least one processing device is further configured to select a cloud service tier based on the mappings and to execute the workload using the selected cloud service tier.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering.

### SUMMARY

Illustrative embodiments of the present disclosure provide techniques for machine learning-based selection of cloud service tiers for workload execution.

In one embodiment, an apparatus comprises at least one processing device comprising a processor coupled to a memory. The at least one processing device is configured to determine a workload to be executed on one or more clouds of one or more cloud service providers for a given user, the workload being associated with a user-defined resource allocation specification. The at least one processing device is also configured to determine a set of cloud service tiers offered by the one or more cloud service providers, each cloud service tier in the set of cloud service tiers being associated with a cloud service provider-defined performance level and a cloud service provider-defined set of features. The at least one processing device is further configured to generate, utilizing at least one machine learning model, a set of mappings between (i) the cloud service provider-defined performance levels and the cloud service provider-defined sets of features for the cloud service tiers in the set of cloud service tiers to (ii) the user-defined resource allocation specification for the workload. The at least one processing device is further configured to select, based at least in part on the generated set of mappings, at least one cloud service tier in the set of cloud service tiers offered by at least one of the one or more cloud service providers, and to execute the workload on one or more clouds of said at least one of the one or more cloud service providers using the selected at least one cloud service tier in the set of cloud service tiers.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based selection of cloud service tiers for workload execution in an illustrative embodiment.

FIG. 2 is a flow diagram of an exemplary process for machine learning-based selection of cloud service tiers for workload execution in an illustrative embodiment.

FIG. 3 shows a system configured for intelligent dynamic tier mapping between cloud vendor tiers and user internal requirements in an illustrative embodiment.

FIG. 4 shows a cloud data integration layer of the FIG. 3 system in an illustrative embodiment.

FIG. 5 shows an intelligent tier mapping layer of the FIG. 3 system in an illustrative embodiment.

FIG. 6 shows a tier analysis layer of the FIG. 3 system in an illustrative embodiment.

FIG. 7 shows a dynamic output layer of the FIG. 3 system in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

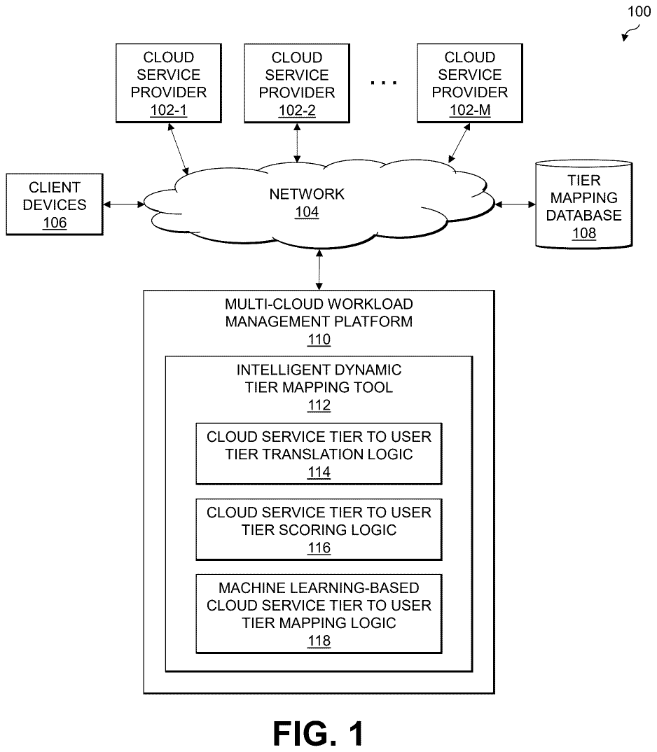

FIG. 1 shows an information processing system 100 configured in accordance with an illustrative embodiment. The information processing system 100 is assumed to be built on at least one processing platform and provides functionality for machine learning-based selection of cloud service tiers for workload execution. The information processing system 100 includes a set of cloud service providers (CSPs) 102-1, 102-2, . . . 102-M (collectively, CSPs 102) which are coupled to a network 104. Also coupled to the network 104 is one or more client devices 106, a tier mapping database 108 and a multi-cloud workload management platform 110. The CSPs 102 operate computing clouds on which workloads may be executed. Such computing clouds may be implemented utilizing various information technology (IT) infrastructure, including physical infrastructure on which virtualization infrastructure running virtual computing instances are instantiated and utilized for executing workloads (e.g., workloads submitted for execution by users of the client devices 106). The physical infrastructure may include physical hardware such as servers, storage systems, networking equipment, etc. The virtualization infrastructure may include hypervisor or containerized computing platforms on which virtual computing instances such as virtual machines (VMs) and software containers run.

The CSPs 102 offer cloud services which may be utilized for running workloads submitted by the client devices 106. Each of the CSPs 102 may offer different cloud service tiers, with each cloud service tier comprising an offering of cloud services with a particular performance level and a set of available features, and which are associated with different costs. Different ones of the CSPs 102 may offer distinct sets of cloud service tiers. When a workload submitted by a user of one of the client devices 106 is scheduled for execution utilizing cloud resources of the CSPs 102, the user-specific requirements for that workload (e.g., a user-specific “internal” service tier) need to be mapped to one or more of the cloud service tiers offered by the CSPs 102. To do so, the client devices 106 may utilize multi-cloud workload management platform 110, which is configured to schedule workloads for execution on clouds of the CSPs 102. The multi-cloud workload management platform 110 implements intelligent dynamic tier mapping tool 112 to appropriately map between the user-specific requirements for workloads and the cloud service tiers offered by the CSPs 102, so that workloads are scheduled for execution on ones of the clouds of the CSPs 102 utilizing appropriate ones of the cloud service tiers which most closely match and meet the user-specific requirements for the workloads.

In some embodiments, the multi-cloud workload management platform 110 is used for an enterprise system. For example, an enterprise may subscribe to or otherwise utilize the multi-cloud workload management platform 110 for performing management of workloads of that enterprise (e.g., submitted by users of client devices 106). As used herein, the term “enterprise system” is intended to be construed broadly to include any group of systems or other computing devices. For example, the multi-cloud workload management platform 110 may provide a portion of one or more enterprise systems. A given enterprise system may also or alternatively include one or more of the client devices 106. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The client devices 106 may comprise, for example, physical computing devices such as Internet of Things (IoT) devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 106 may also or alternately comprise virtualized computing resources, such as VMs, software containers, etc.

The client devices 106 in some embodiments comprise respective computers associated with a particular company, organization or other enterprise. Thus, the client devices 106 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The tier mapping database 108 is configured to store and record various information that is utilized by the multi-cloud workload management platform 110. Such information may include, for example, artificial intelligence (AI) and machine learning (ML) models used for performing tier mapping (e.g., between cloud service tiers and user-defined internal tiers also referred to as user tiers), including AI/ML models such as Retrieval-Augmented Generation (RAG) processing models, semi-supervised learning models, etc., cloud service tier and user tier definitions, user-specific weightings for different tier evaluation criteria, tier mappings, tier performance data, etc. The tier mapping database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the multi-cloud workload management platform 110, as well as to support communication between the multi-cloud workload management platform 110 and other related systems and devices not explicitly shown.

The multi-cloud workload management platform 110 may be provided as a cloud service that is accessible by one or more of the client devices 106 to allow users thereof to perform workload management for workloads of different users of an enterprise, organization or other entity. In some embodiments, the client devices 106 are utilized by members of the same enterprise, organization or other entity that operates the multi-cloud workload management platform 110. In other embodiments, the client devices 106 are utilized by members of one or more enterprises, organizations or other entities different than the enterprise, organization or other entity that operates the multi-cloud workload management platform 110 (e.g., a first enterprise provides support functionality for multiple different customers, businesses, etc.). Various other examples are possible.

In some embodiments, the CSPs 102 and/or the client devices 106 may implement host agents that are configured for automated transmission of information with the tier mapping database 108 and the multi-cloud workload management platform 110 regarding scheduling of workloads for execution on clouds of the CSPs 102. It should be noted that a “host agent” as this term is generally used herein may comprise an automated entity, such as a software entity running on a processing device. Accordingly, a host agent need not be a human entity.

The multi-cloud workload management platform 110 in the FIG. 1 embodiment is assumed to be implemented using at least one processing device. Each such processing device generally comprises at least one processor and an associated memory, and implements one or more functional modules or logic for controlling certain features of the multi-cloud workload management platform 110. In the FIG. 1 embodiment, the multi-cloud workload management platform 110 implements the intelligent dynamic tier mapping tool 112. The intelligent dynamic tier mapping tool 112 comprises cloud service tier to user tier translation logic 114, cloud service tier to user tier scoring logic 116, and machine learning-based cloud service tier to user tier mapping logic 118. The cloud service tier to user tier translation logic 114 is configured to convert or translate cloud service tier descriptions into terms of user service tiers (e.g., user-specific resource allocation specifications). The cloud service tier to user tier scoring logic 116 is configured to generate scores for each of the cloud service tiers, the scores characterizing how closely the performance level and features of the cloud service tiers match up with the user service tiers (e.g., based on user-specific weights assigned to different features). The machine learning-based cloud service tier to user tier mapping logic 118 is configured to utilize at least one machine learning model (e.g., an LLM with RAG functionality) to map specific user tiers associated with workloads to specific cloud service tiers, and to select cloud service tiers for specific workloads based on the mappings. The selected cloud service tiers are used for executing the workloads.

At least portions of the intelligent dynamic tier mapping tool 112, the cloud service tier to user tier translation logic 114, the cloud service tier to user tier scoring logic 116 and the machine learning-based cloud service tier to user tier mapping logic 118 may be implemented at least in part in the form of software that is stored in memory and executed by a processor.

It is to be appreciated that the particular arrangement of the CSPs 102, the client devices 106, the tier mapping database 108 and the multi-cloud workload management platform 110 illustrated in the FIG. 1 embodiment is presented by way of example only, and alternative arrangements can be used in other embodiments. For example, the multi-cloud workload management platform 110 (or portions of components thereof, such as one or more of the intelligent dynamic tier mapping tool 112, the cloud service tier to user tier translation logic 114, the cloud service tier to user tier scoring logic 116 and the machine learning-based cloud service tier to user tier mapping logic 118) may in some embodiments be implemented internal to one or more of the CSPs 102, or one or more clouds of one or more other CSPs.

The multi-cloud workload management platform 110 and other portions of the information processing system 100, as will be described in further detail below, may be part of cloud infrastructure.

The multi-cloud workload management platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The CSPs 102, the client devices 106, the tier mapping database 108 and multi-cloud workload management platform 110 or components thereof (e.g., the intelligent dynamic tier mapping tool 112, the cloud service tier to user tier translation logic 114, the cloud service tier to user tier scoring logic 116 and the machine learning-based cloud service tier to user tier mapping logic 118) may be implemented on respective distinct processing platforms, although numerous other arrangements are possible. For example, in some embodiments at least portions of the multi-cloud workload management platform 110 and one or more of the client devices 106 and/or the tier mapping database 108 are implemented on the same processing platform. A given one of the client devices 106 can therefore be implemented at least in part within at least one processing platform that implements at least a portion of the multi-cloud workload management platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the CSPs 102, the client devices 106, the tier mapping database 108 and the multi-cloud workload management platform 110, or portions or components thereof, to reside in different data centers. Numerous other distributed implementations are possible. The multi-cloud workload management platform 110 can also be implemented in a distributed manner across multiple data centers.

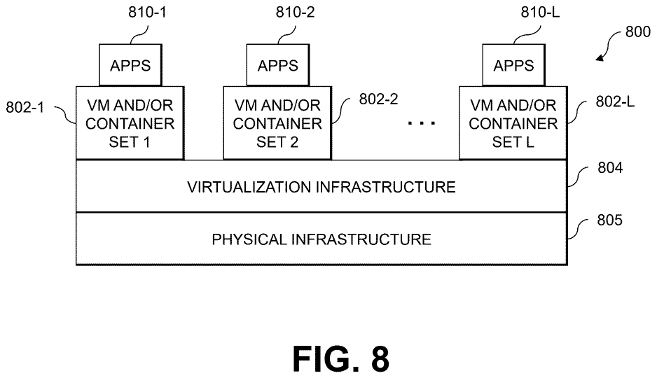

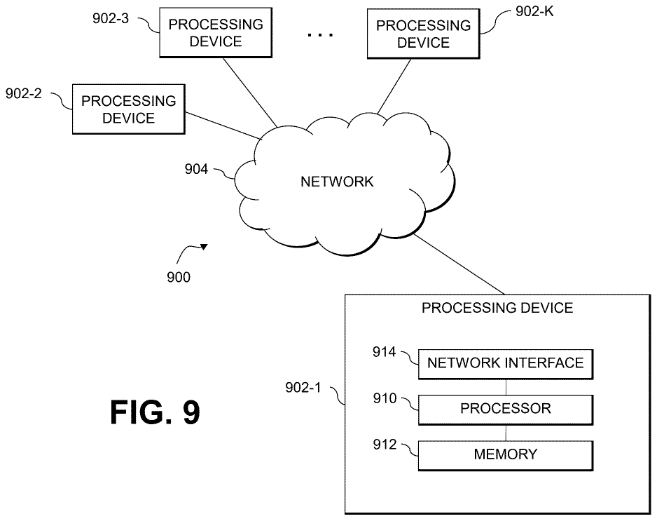

Additional examples of processing platforms utilized to implement the multi-cloud workload management platform 110 and other components of the information processing system 100 in illustrative embodiments will be described in more detail below in conjunction with FIGS. 8 and 9.

It is to be understood that the particular set of elements shown in FIG. 1 for machine learning-based selection of cloud service tiers for workload execution is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

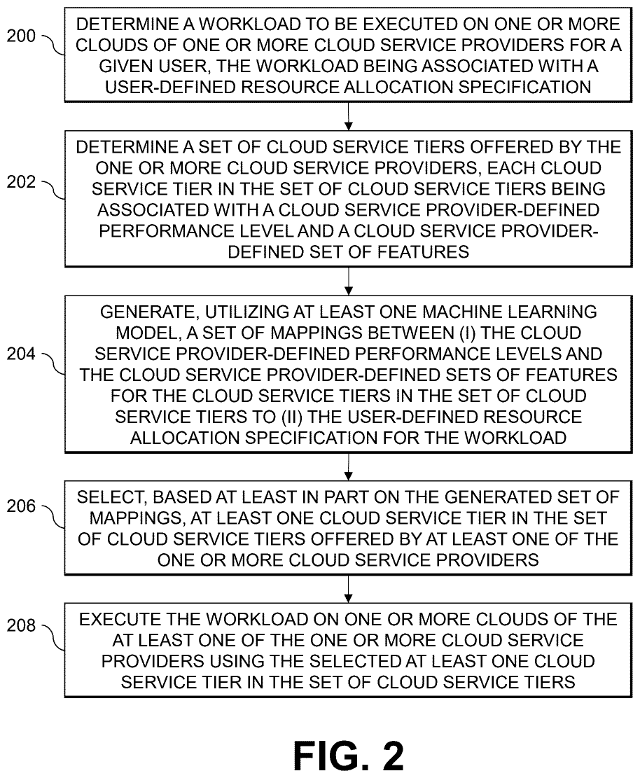

An exemplary process for machine learning-based selection of cloud service tiers for workload execution will now be described in more detail with reference to the flow diagram of FIG. 2. It is to be understood that this particular process is only an example, and that additional or alternative processes for machine learning-based selection of cloud service tiers for workload execution may be used in other embodiments.

In this embodiment, the process includes steps 200 through 208. These steps are assumed to be performed by the multi-cloud workload management platform 110 utilizing the intelligent dynamic tier mapping tool 112, the cloud service tier to user tier translation logic 114, the cloud service tier to user tier scoring logic 116 and the machine learning-based cloud service tier to user tier mapping logic 118. The process begins with step 200, determining a workload to be executed on one or more clouds of one or more cloud service providers for a given user, the workload being associated with a user-defined resource allocation specification. The given user may be part of an organization, and the user-defined resource allocation specification may be an organization-wide resource allocation specification. In step 202, a set of cloud service tiers offered by the one or more cloud service providers is determined. Each cloud service tier in the set of cloud service tiers is associated with a cloud service provider-defined performance level and a cloud service provider-defined set of features.

A set of mappings between (i) the cloud service provider-defined performance levels and the cloud service provider-defined sets of features for the cloud service tiers in the set of cloud service tiers to (ii) the user-defined resource allocation specification for the workload is generated in step 204 utilizing at least one machine learning model. The at least one machine learning model may comprise an LLM with RAG functionality. Generating the set of mappings may be based at least in part on vendor pricing models set by the one or more cloud service providers for the set of cloud service tiers. Generating the set of mappings may be based at least in part on compliance requirements in the user-defined resource allocation specification and/or operational metrics in the user-defined resource allocation specification.

At least one cloud service tier in the set of cloud service tiers offered by at least one of the one or more cloud service providers is selected in step 206 based at least in part on the generated set of mappings, at least one cloud service tier in the set of cloud service tiers offered by at least one of the one or more cloud service providers. Selecting the at least one cloud service tier may be further based at least in part on determining resource utilization trends for the set of cloud service tiers and/or determining real-time performance analytics for the set of cloud service tiers. The workload is executed in step 208 on one or more clouds of the at least one of the one or more cloud service providers using the selected at least one cloud service tier in the set of cloud service tiers.

In some embodiments, selecting the at least one cloud service tier utilizes a semi-supervised machine learning model that is configured to refine the generated set of mappings. Refining the generated set of mappings may be based at least in part on real-time predictive performance metrics generated for each cloud service tier in the set of cloud service tiers. The predictive performance metrics may comprise modeled resource demands associated with each cloud service tier in the set of cloud service tiers. The predictive performance metrics may be generated using a predictive model with regression analysis that takes as input historical performance data for each cloud service tier in the set of cloud service tiers. Refining the generated set of mappings may be based at least in part on a set of user weights derived from the user-defined resource allocation specification for the workload, the set of user weights being associated with different metrics associated with the cloud service tiers. The metrics associated with the cloud service tiers may comprise: one or more performance benchmarks; one or more cost-performance ratios; and one or more workload optimization metrics.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In multi-cloud computing environments, enterprises face challenges in efficiently managing and mapping distinct vendor-specific tiering schemes to their own internal resource allocation strategies. Without a system to unify these tiers, organizations struggle with misaligned resources, increased operational costs, and reduced efficiency in workload optimization. Conventional approaches typically rely on manual intervention or static templates, and lack the flexibility to adapt to vendor-specific changes or customer-specific requirements. Moreover, the absence of real-time decision-making tools that can integrate historical performance data results in suboptimal tiering decisions. This leads to resource wastage, operational inefficiencies and poor cost control. Illustrative embodiments provide technical solutions for intelligent and dynamic tier mapping with functionality for automating and optimizing complex mapping processes (e.g., between vendor-specific storage tiering schemes and a user or other entity's internal resource allocation strategy), ensuring precise alignment between vendor offerings and organizational priorities, while reducing overhead and improving overall cloud performance.

Consider, for example, an enterprise, organization or other entity which uses multiple cloud vendors. A given cloud vendor may have an “enterprise” resource tier that needs to be mapped to the entity's internal “gold” tier for mission-critical workloads. Without an automated system, an IT team may spend hours manually aligning the tiers, leading to delays and misallocation of resources. Using the technical solutions described herein, it is possible to automatically translate and map the vendor's tiers to the entity's requirements in real-time, optimizing resource utilization across clouds in a multi-cloud operating environment.

As used herein, a “tier” refers to a predefined category of cloud services offered by a vendor. Tiers may indicate levels of performance, available features, pricing, etc. An enterprise, organization or other entity consuming cloud services offered by vendors must map the tiers to internal resource allocation strategies. Retrieval-Augmented Generation (RAG) is a type of ML model, and is used in some embodiments to combine real-time data retrieval with AI generation to enhance the accuracy of tier mapping by integrating up-to-date vendor information. Semi-supervised learning is a ML approach that uses a combination of labeled and unlabeled data, and is leveraged in some embodiments for refining tier mapping accuracy even with limited training data from diverse cloud vendors. The technical solutions described herein provide functionality for automatically translating vendor-defined tiers into customer or other user-specific tiers, optimizing cloud resource allocation based on AI-driven insights. A true positive (TP) refers to a correctly identified match between a vendor's tier and a customer or other user's internal defined tier, reflecting the accuracy of the AI in aligning multi-cloud resources. A true negative (TN) refers to a correctly identified non-match between a vendor's tier and a customer or other user's internal defined tier, helping to avoid resource misallocation across multi-cloud environments. Multi-cloud management refers to the practice of managing multiple cloud services from different vendors. The technical solutions described herein enhance multi-cloud management by automating tier translation and improving decision-making efficiency.

Organizations face various technical challenges in aligning diverse cloud vendor tiering schemes with their internal resource allocation strategies, leading to inefficiencies and mismanagement. These tiering schemes often vary in terms of cost, performance, availability and service level agreements (SLAs), making it difficult to ensure optimal resource usage. Over-provisioning or under-utilizing resources can significantly increase operational costs and complexity. Further, the manual effort required to align and track resources across different cloud platforms creates bottlenecks in scalability. There is also a need for real-time visibility and adaptive resource allocation to optimize workloads. The technical solutions described herein provide functionality for dynamically mapping and optimizing tiering schemes across multi-cloud environments.

Conventional approaches primarily rely on manual mapping of vendor tiering schemes to customer or user-defined tiers, which can be time-consuming and prone to errors. Administrators must constantly update mappings as cloud vendors adjust their offerings, leading to potential misalignment with business needs. Some tools offer predefined templates for tiering, but they lack flexibility and fail to accommodate the unique requirements of individual organizations. Moreover, these templates often do not account for changes in resource demand or vendor pricing, making them less effective in dynamic cloud environments. Even tools which provide basic automation typically do not integrate historical usage data or leverage real-time analytics to optimize resource allocation. This lack of integration results in poor decision-making, especially in scenarios where quick adjustments are needed. Additionally, conventional tools rarely offer seamless compatibility across multiple cloud platforms, further complicating the management of hybrid or multi-cloud strategies. These and other technical limitations hinder the ability of conventional approaches to effectively balance cost, performance and scalability in a rapidly evolving cloud landscape.

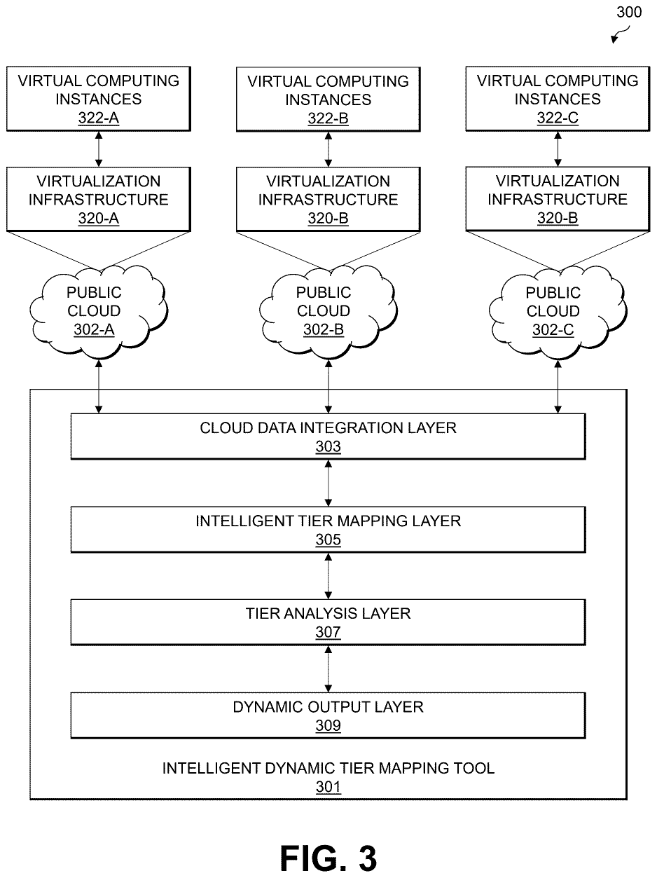

The technical solutions described herein overcome these and other issues in multi-cloud operating environments through implementation of intelligent dynamic tier mapping tools that leverage RAG and semi-supervised machine learning models. FIG. 3 shows a system 300 implementing an intelligent dynamic tier mapping tool 301, which includes a cloud data integration layer 303, an intelligent tier mapping layer 305, a tier analysis layer 307, and a dynamic output layer 309. The cloud data integration layer 303 is configured to obtain data from a multi-cloud operating environment, which in the example of FIG. 3 includes a set of public clouds 302-A, 302-B and 302-C (collectively, public clouds 302), which implement respective sets of virtualization infrastructure 320-A, 320-B and 320-C (collectively, virtualization infrastructure 320) which run respective sets of virtual computing instances 322-A, 322-B and 322-C (collectively, virtual computing instances 322). The virtualization infrastructure 320 may comprise, for example, virtualization platforms such as VMware vSphere®, Microsoft Hyper-V®, etc. The virtual computing instances 322 may comprise VMs, containers, etc. The intelligent tier mapping layer 305 is configured to aggregate and preprocess cloud vendor data (e.g., for public clouds 302, obtained via cloud data integration layer 303) while translating it into a customer or other user's organizational internal tier definitions. The tier analysis layer 307 provides a dynamic mapping engine for executing the translation, ensuring criteria prioritization based on user input. The tier analysis layer 307 is also configured to provide an adaptive decision framework for continuously assessing and refining tier assignments, enhancing decision-making through predictive analytics. The dynamic output layer 309 provides intelligent translation functionality and serves as an interface that facilitates seamless interaction between vendor tiers and customer or other end-user requirements, creating a cohesive and responsive mapping system. Together, these components and layers enable the intelligent dynamic tier mapping tool 301 to provide an agile framework for optimizing resource allocation and enhancing operational efficiency across diverse cloud platforms.

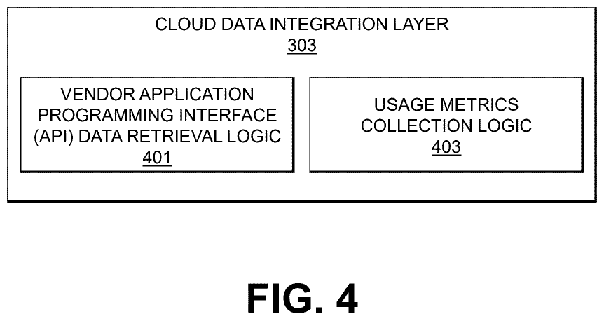

FIG. 4 shows a detailed view of the cloud data integration layer 303, which implements vendor API data retrieval logic 401 and usage metrics collection logic 403. The vendor API data retrieval logic 401 is configured to utilize vendor APIs (e.g., of the public clouds 302) to obtain information regarding vendor tier definitions (e.g., for tiers offered by different ones of the public clouds 302). The usage metrics collection logic 403 is configured to collect usage metrics from the public clouds 302.

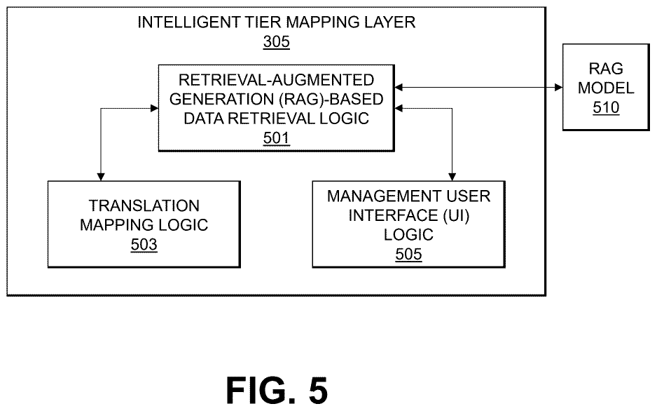

FIG. 5 shows a detailed view of the intelligent tier mapping layer 305, which implements RAG-based data retrieval logic 501, translation mapping logic 503 and management user interface (UI) logic 505. The intelligent tier mapping layer 305 is configured to aggregate and preprocess data from diverse cloud vendors (e.g., the public clouds 302, which the data is obtained from the public clouds 302 via the cloud data integration layer 303). The RAG-based data retrieval logic 501 is configured to use a RAG model 510 to enhance data retrieval efficiency and relevance. The RAG-based data retrieval logic 501 is configured to collect various features for training a tier mapping or translation model, including vendor tier definitions, SLAs, historical performance metrics, resource utilization patterns, etc. The translation mapping logic 503 is configured to implement a translation layer that maps vendor tiers to customer or other user-specific definitions based on predefined criteria. The translation mapping logic 503 may utilize the tier analysis layer 307 which, as described in further detail below, leverages semi-supervised machine learning to synthesize labeled data (e.g., from previous mappings) with unlabeled data (e.g., for new vendor offerings) to effectively classify and adapt to various vendor tiering schemes in real-time. The management UI logic 505 is configured to provide a management UI, allowing customers or other users to interact with the intelligent tier mapping layer 305.

The effectiveness of the intelligent tier mapping layer 305 may be evaluated via its accuracy, which may be mathematically represented as:

$$Accuracy = \frac{True Positives + True Negatives}{Total Predictions}$$

True positives (TP) correspond to cases where correct matching tier predictions are identified, while true negatives (TN) correspond to cases where correct non-matching tier predictions are confirmed. The total predictions include all predictions made by the model. Through evaluating the accuracy, it is possible to determine how effective the intelligent tier mapping layer 305 is in mapping vendor tiers to customer or other user-defined tiers. By continuously updating its feature set and retraining the model based on accuracy results, it is possible to ensure optimal or improved performance and adaptability within multi-cloud architectures.

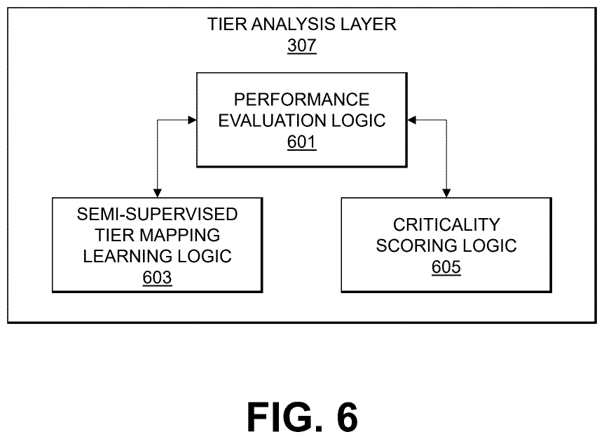

FIG. 6 shows a detailed view of the tier analysis layer 307, which implements performance evaluation logic 601, semi-supervised tier mapping learning logic 603, and criticality scoring logic 605. The tier analysis layer 307 provides a dynamic mapping engine, and serves to execute real-time translations of vendor tiers into customer-defined tiers using sophisticated algorithms. The performance evaluation logic 601 is configured to determine various performance benchmarks (e.g., CPU usage, memory utilization, etc.), cost-performance ratios, workload optimization metrics, etc. The semi-supervised tier mapping learning logic 603 is configured to utilize a semi-supervised learning approach to improve tier mapping accuracy by utilizing both labeled and unlabeled data as discussed above. The criticality scoring logic 605 is configured to assign scores to each tier based on business impact and resource importance, guiding decision-making.

In cases where direct correlations between tier definitions are lacking, the criticality scoring logic 605 may be used to determine a comprehensive set of matching criteria which can be prioritized based on user-defined importance, ensuring alignment with business goals. In some embodiments, a weighted scoring system is used to facilitate tier mapping:

Tier Score=Σwᵢ·fᵢ

where wᵢ is the weight assigned to feature i, and fᵢ is the feature value for feature i. This formula enables the dynamic mapping engine to calculate a score for each potential tier mapping, allowing it to recommend the most appropriate tier based on user-defined priorities. By allowing for adjustment of the weights, customer or other users can directly influence the mapping outcomes based on their unique operational needs.

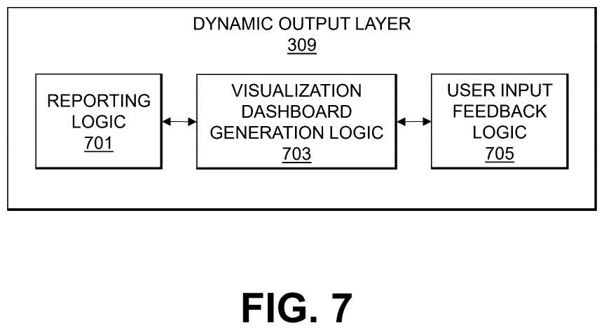

FIG. 7 shows a detailed view of the dynamic output layer 309, which implements reporting logic 701, visualization dashboard generation logic 703 and user input feedback logic 705. The reporting logic 701 is configured to generate and output reports relating to tier mappings and performance for workloads which run on cloud resources of the public clouds 302 selected using the tier mappings. The visualization dashboard generation logic 703 is configured to generate a visualization dashboard for presenting the generated reports and other information relating to tier mappings. The user input feedback logic 705 is configured to obtain user feedback (e.g., regarding tier mappings, custom weights for different features for tuning tier assignments or mappings to specific user needs, etc.).

The intelligent dynamic tier mapping tool 301 provides an adaptive decision framework, which integrates insights from the tier analysis layer 307 to produce strategic, data-driven recommendations for tier assignments in multi-cloud environments via the intelligent tier mapping layer 305. The adaptive decision framework continuously evaluates the effectiveness of tier mappings against real-time performance analytics and resource utilization trends. Key features include predictive analytics for modelling future resource demands and identifying performance bottlenecks, allowing for proactive tier adjustments. The adaptive decision framework may employ a predictive model based on regression analysis:

ŷ=β₀+β₁x₁+β₂x₂+ . . . +βₙxₙ

where ŷ is the predicted performance metric, β₀ is the intercept, and βᵢ (i=1 . . . n) are the coefficients for features xᵢ. By analyzing historical data and projecting future trends, the framework enhances decision-making processes, enabling resource managers to optimize their cloud investments dynamically while ensuring alignment with evolving business requirements.

The intelligent tier mapping layer 305 of the intelligent dynamic tier mapping tool 301 is configured to encapsulate the AI algorithms and logic for translating tier definitions. The intelligent tier mapping layer 305 acts an interface between vendor tiering schemes and customer or other user or organizational tier definitions, utilizing features such as vendor pricing models, compliance requirements and operational metrics. By providing a user-friendly management UI, the intelligent tier mapping layer 305 ensures seamless interaction and ongoing adjustments based on user input and new data. The translation process can be expressed through a mapping function:

T:V→C

where T is the translation function, V represents the vendor tier definitions, and C represents the customer or other user's internal organizational tiers. This mathematical representation captures the essence of mapping vendor tiers to customer or other user needs, allowing for dynamic updates as either side changes. By maintaining a robust prioritization system, the intelligent tier mapping layer 305 empowers users to refine tier mappings actively, ensuring the final solution is intelligent, adaptable and aligned with specific user or organizational objectives.

The technical solutions described herein provide functionality for dynamically mapping vendor tiering schemes to customer or other user-specific definitions, enhancing decision-making through leveraging RAG and semi-supervised machine learning. By utilizing RAG combined with semi-supervised machine learning, the technical solutions described herein are advantageously able to continuously adapt to real-time changes in vendor tier offerings and changes in customer or other user-specific internal tiering requirements. The intelligent translation provides a key differentiator, enabling precise and automated translations of vendor tiers into user or organizational equivalents. The ability to evolve with shifting vendor offerings and internal user or organizational priorities ensures long-term alignment. The technical solutions further advantageously facilitate cross-platform integration, providing control and flexibility in multi-cloud operating environments. The automated tier mapping functionality advantageously reduces manual intervention and improves efficiency in multi-cloud resource management, and further enhances decision accuracy by leveraging real-time data and historical insights through AI-driven optimization. The technical solutions described herein seamlessly support multi-cloud environments by dynamically translating diverse vendor tiering schemes into unified, customer or other user-specific organizational tiers across different cloud platforms. The technical solutions described herein leverage advanced AI techniques to set new standards in intelligent multi-cloud resource optimization and automated decision-making.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based selection of cloud service tiers for workload execution will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100 in FIG. 1. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a central processing unit (CPU), a graphics processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based selection of cloud service tiers for workload execution as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine a workload to be executed on one or more clouds of one or more cloud service providers for a given user, the workload being associated with a user-defined resource allocation specification;
to determine a set of cloud service tiers offered by the one or more cloud service providers, each cloud service tier in the set of cloud service tiers being associated with a cloud service provider-defined performance level and a cloud service provider-defined set of features;
to generate, utilizing at least one machine learning model, a set of mappings between (i) the cloud service provider-defined performance levels and the cloud service provider-defined sets of features for the cloud service tiers in the set of cloud service tiers to (ii) the user-defined resource allocation specification for the workload;
to select, based at least in part on the generated set of mappings, at least one cloud service tier in the set of cloud service tiers offered by at least one of the one or more cloud service providers; and
to execute the workload on one or more clouds of said at least one of the one or more cloud service providers using the selected at least one cloud service tier in the set of cloud service tiers.

2. The apparatus of claim 1 wherein the at least one machine learning model comprises a Large Language Model (LLM) with Retrieval-Augmented Generation (RAG).

3. The apparatus of claim 1 wherein selecting the at least one cloud service tier utilizes a semi-supervised machine learning model that is configured to refine the generated set of mappings.

4. The apparatus of claim 3 wherein refining the generated set of mappings is based at least in part on real-time predictive performance metrics generated for each cloud service tier in the set of cloud service tiers.

5. The apparatus of claim 4 wherein the predictive performance metrics comprise modeled resource demands associated with each cloud service tier in the set of cloud service tiers.

6. The apparatus of claim 4 wherein the predictive performance metrics are generated using a predictive model with regression analysis that takes as input historical performance data for each cloud service tier in the set of cloud service tiers.

7. The apparatus of claim 3 wherein refining the generated set of mappings is based at least in part on a set of user weights derived from the user-defined resource allocation specification for the workload, the set of user weights being associated with different metrics associated with the cloud service tiers.

8. The apparatus of claim 7 wherein the metrics associated with the cloud service tiers comprise: one or more performance benchmarks; one or more cost-performance ratios; and one or more workload optimization metrics.

9. The apparatus of claim 1 wherein the given user is part of an organization, and wherein the user-defined resource allocation specification comprises an organization-wide resource allocation specification.

10. The apparatus of claim 1 wherein generating the set of mappings is based at least in part on vendor pricing models set by the one or more cloud service providers for the set of cloud service tiers.

11. The apparatus of claim 1 wherein generating the set of mappings is based at least in part on compliance requirements in the user-defined resource allocation specification.

12. The apparatus of claim 1 wherein generating the set of mappings is based at least in part on operational metrics in the user-defined resource allocation specification.

13. The apparatus of claim 1 wherein selecting the at least one cloud service tier is further based at least in part on determining resource utilization trends for the set of cloud service tiers.

14. The apparatus of claim 1 wherein selecting the at least one cloud service tier is further based at least in part on determining real-time performance analytics for the set of cloud service tiers.

15. A computer program product comprising a non-transitory processor-readable storage medium having stored therein program code of one or more software programs, wherein the program code when executed by at least one processing device causes the at least one processing device:
to determine a workload to be executed on one or more clouds of one or more cloud service providers for a given user, the workload being associated with a user-defined resource allocation specification;
to determine a set of cloud service tiers offered by the one or more cloud service providers, each cloud service tier in the set of cloud service tiers being associated with a cloud service provider-defined performance level and a cloud service provider-defined set of features;
to generate, utilizing at least one machine learning model, a set of mappings between (i) the cloud service provider-defined performance levels and the cloud service provider-defined sets of features for the cloud service tiers in the set of cloud service tiers to (ii) the user-defined resource allocation specification for the workload;
to select, based at least in part on the generated set of mappings, at least one cloud service tier in the set of cloud service tiers offered by at least one of the one or more cloud service providers; and
to execute the workload on one or more clouds of said at least one of the one or more cloud service providers using the selected at least one cloud service tier in the set of cloud service tiers.

16. The computer program product of claim 15 wherein the at least one machine learning model comprises a Large Language Model (LLM) with Retrieval-Augmented Generation (RAG).

17. The computer program product of claim 15 wherein selecting the at least one cloud service tier utilizes a semi-supervised machine learning model that is configured to refine the generated set of mappings.

18. A method comprising:
determining a workload to be executed on one or more clouds of one or more cloud service providers for a given user, the workload being associated with a user-defined resource allocation specification;
determining a set of cloud service tiers offered by the one or more cloud service providers, each cloud service tier in the set of cloud service tiers being associated with a cloud service provider-defined performance level and a cloud service provider-defined set of features;
generating, utilizing at least one machine learning model, a set of mappings between (i) the cloud service provider-defined performance levels and the cloud service provider-defined sets of features for the cloud service tiers in the set of cloud service tiers to (ii) the user-defined resource allocation specification for the workload;
selecting, based at least in part on the generated set of mappings, at least one cloud service tier in the set of cloud service tiers offered by at least one of the one or more cloud service providers; and
executing the workload on one or more clouds of said at least one of the one or more cloud service providers using the selected at least one cloud service tier in the set of cloud service tiers;
wherein the method is performed by at least one processing device comprising a processor coupled to a memory.

19. The method of claim 18 wherein the at least one machine learning model comprises a Large Language Model (LLM) with Retrieval-Augmented Generation (RAG).

20. The method of claim 18 wherein selecting the at least one cloud service tier utilizes a semi-supervised machine learning model that is configured to refine the generated set of mappings.
